(19) United States
(12) Patent Application Publication
(10) Pub. No.: US 2009/0147081 A1
(43) Pub. Date: Jun. 11, 2009

(54) HAIR STYLING SYSTEM AND APPARATUS

(76) Inventor: Thomas Hanson, Sioux Falls, SD (US)

Correspondence Address: MAIER & MAIER, PLLC, 1000 DUKE STREET, ALEXANDRIA, VA, 22314, US

(21) Appl. No.: 12/328,334

(22) Filed: Dec. 4, 2008

Related U.S. Application Data
(60) Provisional application No. 60/992,367, filed on Dec. 5, 2007.

(51) Int. Cl. H04N 7/18; A45D 24/16; A45D 24/10; A45D 24/00

(52) U.S. Cl. 348/77; 132/120; 132/148; 132/150; 348/E07.085

(57) ABSTRACT

A hair styling apparatus that may include a body portion; a handle portion that may extend away from the body portion; and a camera unit that may be coupled to the body portion, the camera unit may include a camera unit body portion; a lens that may be coupled to the camera unit body portion; and a transmitter that may be coupled within the camera unit body portion, wherein the transmitter may be operatively coupled to the lens.

### CROSS-REFERENCE TO RELATED APPLICATIONS

This application claims priority to U.S. Provisional Application No. 60/992,367, filed Dec. 5, 2007, and entitled HAIR STYLING TOOL, the entire contents of which are hereby incorporated by reference.

### BACKGROUND OF THE INVENTION

Hair styling tools such as combs, brushes, hair dryers and curling irons are commonly used to facilitate styling an individual's hair. When styling the back of an individual's head, the individual typically cannot adequate see the back of their head with the use of two or more mirrors. The use of two mirrors may be difficult because the mirrors must be placed and oriented such that each mirror is angled with respect to the other to enable the individual to see the back of their head.

The use of two mirrors may not enable the individual to continue styling their hair while looking at the reflection of the back of their head. Typically, the individual must make adjustments and then check those adjustments before attempting any further corrections. As a result, the individual may not see the back of their head in real time as they make adjustments to their hair or other parts of their ensemble.

### BRIEF DESCRIPTION OF THE INVENTION

In one aspect, a hair styling apparatus may be provided. The hair styling apparatus may include a body portion; a handle portion that may extend away from the body portion; and a camera unit that may be coupled to the body portion, the camera unit may include a camera unit body portion; a lens that may be coupled to the camera unit body portion; and a transmitter that may be coupled within the camera unit body portion, wherein the transmitter may be operatively coupled to the lens.

In another aspect, a hair styling system may be provided. The hair styling system may include a hair styling apparatus that may include a body portion; a handle portion that may extend away from the body portion; and a camera unit that may be coupled to the body portion, the camera unit may include a camera unit body portion; a lens that may be coupled to the camera unit body portion; and a transmitter that may be coupled within the camera unit body portion, wherein the transmitter may be operatively coupled to the lens; and at least one smart device that may be coupled in communication with the hair styling apparatus, the at least one smart device may include a transceiver; and a monitor operatively coupled to the transceiver to facilitate displaying image data received by the transmitter.

In yet another aspect, a means for capturing and transmitting image data may be provided. The mean may include means for capturing image data using a hair styling apparatus; means for transmitting image data to at least one smart device; and means for displaying image data on the at least one smart device.

### BRIEF DESCRIPTION OF THE DRAWINGS

Advantages of embodiments of the present invention will be apparent from the following detailed description of the exemplary embodiments thereof. The following detailed description should be considered in conjunction with the accompanying figures in which:

FIG. 1a is a top view of a hair styling tool;

FIG. 1b is a side view of the hair styling tool shown in FIG. 1;

FIG. 1c is a bottom view of the hair styling tool shown in FIG. 1;

FIG. 2a is a perspective view of an alternative embodiment of the hair styling tool shown in FIG. 1;

FIG. 2b is a perspective rear view of a camera unit that may be used with the hair styling tool shown in FIG. 2a;

FIG. 2c is a perspective from view of the camera unit shown in FIG. 2b;

FIG. 3 is a cross-sectional side view of the hair styling tool shown in FIG. 2a;

FIG. 4 is a schematic view of a hair styling system that may be used with the hair styling tools shown in FIG. 1 and 2a;

FIG. 5 is a side view of a wall mount that may be used with the system shown in FIG. 4;

FIG. 6a is a side view of an alternative embodiment of the hair styling tool shown in FIG. 1;

FIG. 6b is a rear view of the hair styling tool shown in FIG. 6a;

FIG. 7 is a top view of an alternative embodiment of hair styling tool shown in FIG. 1;

FIG. 8 is a top view of another alternative embodiment of the hair styling tool shown in FIG. 1;

FIG. 9 is a front view of an extension device that may be used with the hair styling too shown in FIG. 1;

FIG. 10 is an alternative embodiment of a hair styling tool; and

FIG. 11 is a rear view of an alternative embodiment of the hair styling tool shown in FIG. 1.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance, or illustration.” The embodiments described herein are not limiting, but rather are exemplary only. It should be understood that the described embodiment are not necessarily to be construed as preferred or advantageous over other embodiments. Moreover, the term “embodiments of the invention” does not require that all embodiments of the invention include the discussed feature, advantage or mode of operation.

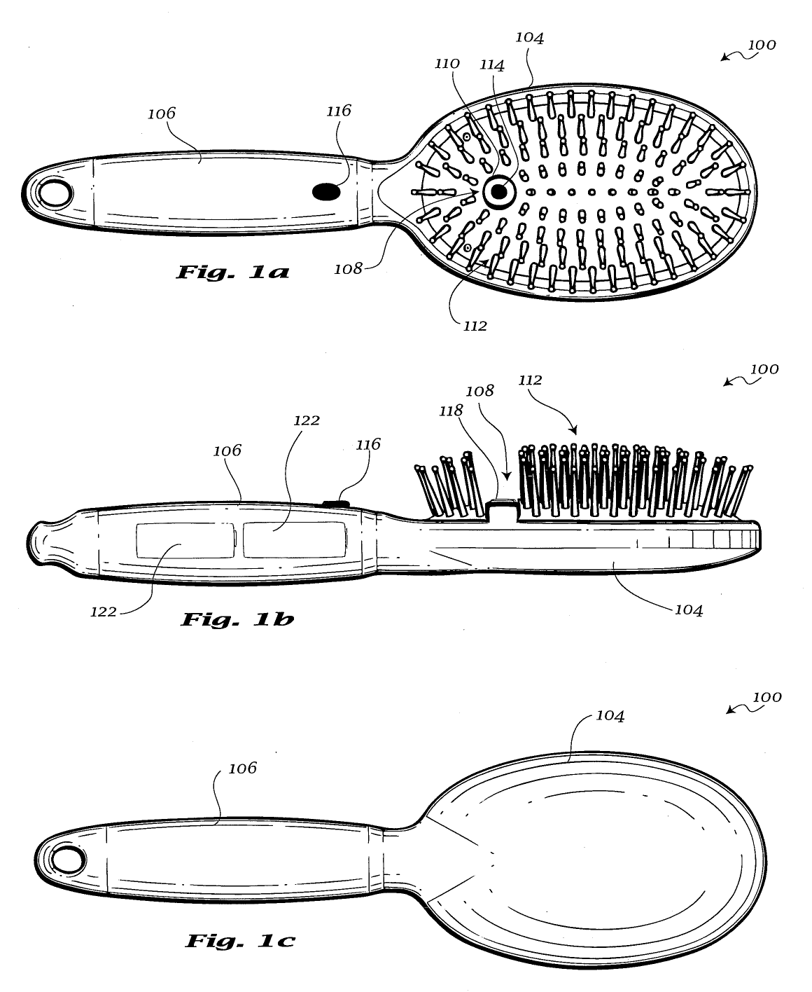

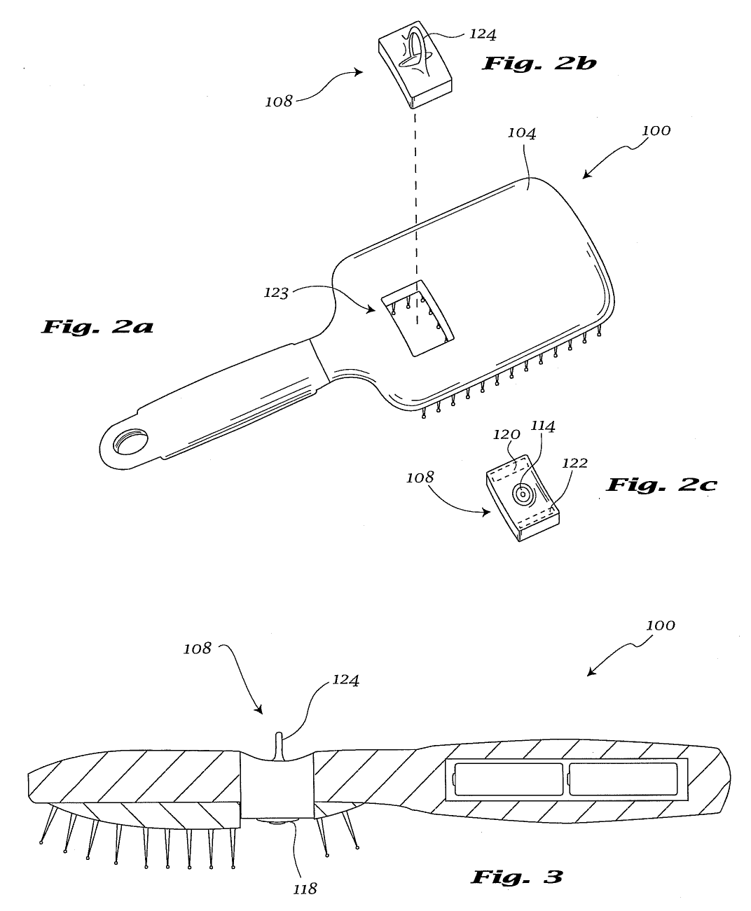

Turning to the accompanying figures, a hair styling tool 100 is described, wherein hair styling tool 100 may be used with a hair styling system 102, as shown in FIG. 4 and as described in more detail below. FIG. 1a is a top view of hair styling tool 100, FIG. 1b is a side view of hair styling tool 100 and FIG. 1c is a bottom view of hair styling tool 100. FIG. 2a is a perspective view of an alternative embodiment of hair styling tool 100, FIG. 2b is a perspective rear view of a camera unit 108 and FIG. 2c is a perspective front view of camera unit 108. In the exemplary embodiment, hair styling tool 100 may generally include a body portion 104, a handle portion 106 extending away from body portion 104 and camera unit 108 coupled to body portion 104. In one embodiment, handle portion 106 may include a grip (not shown) coupled thereto that enables people with disabilities, left handed people and right handed people to hold hair styling tool 100. Hair styling tool 100 may also include a first aperture 110 defined in body portion 104, wherein camera unit may be positioned substantially within first aperture 110. In the exemplary embodiment, hair styling tool 100 may be a hair brush and may include a plurality of bristles 112 that are coupled to body portion 104 and extending away therefrom. First aperture 110 may be defined in body portion 104 such that aperture is substantially perpendicular to bristles 112. Alternatively, hair styling tool 100 may be, but not limited to, a comb, a hair curler, a hair crimper, a hair dryer and/or any other hair styling tool. In another embodiment, hair styling tool 100 may be made of materials such as, but not limited to, plastic, metal, wood and /or any other material known to a person having ordinary skill in the art that enables hair styling tool 100 to function as described herein.

In one embodiment, as shown in FIGS. 1a-1c, camera unit 108 may be coupled within hair styling tool 100 such that camera unit 108 is substantially enclosed therein. Moreover, camera unit 108 may be positioned within aperture 110 such that a camera lens 114 is directed in a direction that is substantially parallel to bristles 112. In an alternative embodiment, hair styling tool 100 may include a plurality of camera units 108. Hair styling tool 100 may also include a switch 116 that facilitates either turning on or turning off camera unit 108. In one embodiment, switch 116 may be, but not limited to, a toggle switch and/or any other type of switch that enables hair styling tool 100 to function as described herein. Hair styling tool 100 may also include a transparent protective member 118 that may be coupled to body portion 104 such that protective member 118 may be positioned substantially adjacent aperture 110. As a result, protective member 118 (shown in FIG. 1b) may be positioned between an outside environment (not shown) and camera unit 108 such that protective member 118 facilitates protecting camera unit 108 from damage or from chemicals commonly used in hair.

As shown in FIG. 2c, camera unit 108 may include camera lens 114, a transmitter 120 and a power source 122, wherein camera lens 114 may be operatively coupled to transmitter 120 and power source 122 such that camera lens 114 may capture images and transmit the captured images to a smart device 126 (shown in FIG. 4), as described in more detail below. Alternatively, power source 122 may be coupled within hair styling tool 100, as shown in FIG. 1b. Power source 122 may be, but not limited to, at least one battery, an Alternative Current power source, a solar power source and/or any other power source that enables camera unit 108 to function as described herein. In one embodiment, camera lens 114 may capture and transmit moving pictures and/or still pictures to smart device 126. Transmitter 120 may transmit data to smart device 126 wirelessly through a variety of different methods, for example, via Bluetooth technology, infrared, radio frequency, Wi-Fi, wide-band and/or any other type of wireless communication technology that enables system 102 to function as described herein.

In one embodiment, camera lens 114 may be rotatably coupled to camera unit 108 such that camera lens 114 may be movable and rotatable with respect to camera unit 108. In such an embodiment, a user may rotate camera lens 114 with respect to camera unit 108 to facilitate angling camera lens 114 towards an object, as described in more detail below.

In yet another embodiment, camera unit may be removable from hair styling tool 100, as shown in FIGS. 2a, 2b, 2c and 3. In such an embodiment, hair styling tool 100 may include a second aperture 123 defined in body portion 104, wherein second aperture 123 extends substantially through body portion 104. Camera unit 108 may be removably coupled to hair styling tool 100 and may be positioned substantially within second aperture 123. As a result, the user may remove camera unit 108 from hair styling tool 100 to facilitate manually angling camera lens 114 towards an object to be viewed. In such an embodiment, camera unit 108 may include a handle 124 extending away therefrom, wherein handle 124 may include, but not limited to, a hook and a tab. In the exemplary embodiment, handle 124 may be a loop that enables the user to insert one or more fingers therethrough. The removable camera unit 108 may also include a switch coupled thereto (not shown) that facilitates either turning on or turning off camera unit 108.

Hair styling tool 100 may be used in styling system 102, as shown in FIG. 4. Styling system 102 may include smart device 126, which may have a monitor 128 that enables viewing of the video and/or picture data transmitted by camera unit 108. Smart device 126 may receive wireless transmissions using a variety of different methods, such as, for example, Bluetooth technology, infrared, radio frequency, Wi-Fi, wide-band and/or any other type of wireless communication technology that enables system 102 to function as described herein. In the exemplary embodiment, smart device 126 may be a mobile telephone that includes display monitor 128. Alternatively, smart device 126 may include, but not limited to, a computer, a music player, a video player, a television, an automobile navigation system screen, a video game player, a personal digital assistant (“PDA”), a computer and/or any other device that is enabled to receive wireless transmissions and display video and/or images. In one embodiment, camera unit 108 may transmit a reversed version of the captured image such that monitor 128 may display a reversed, or mirror, image. In another embodiment, camera unit 108 may include a storage device (not shown) coupled to camera lens 114, transmitter 120 and power source 122. The storage device may enable the user to record images captured by camera lens 114 for playback at a later time. Alternatively, the storage device may facilitate displaying pre-recorded images or playing pre-recorded audio.

Although system 102 may be used in any event where the capture and wireless transmission of image data is desired, a non-limiting example pertaining to capturing images of the back of a user's head is used to describe the operation of system 102.

During operation, the user may use hair styling tool 100, and more specifically, camera unit 108 to view parts of the body that the user cannot readily see due to the physical limitations of the human body. For example, the user may use camera unit 108 to view the back of the user's head to enable the user to see how their hair looks. In the exemplary embodiment, the user may activate camera unit 108 by turning switch 116 on. In one embodiment, the user may adjust the angle of camera lens 114 with respect to camera unit 108 and/or body portion 104. Once camera unit 108 has been turned on, camera lens 114 facilitates capturing video and/or still images and transmitter 120 facilitates transmitting the video and/or still images wirelessly to smart device 126. Smart device 126 may receive the wireless transmissions of the image data. Smart device 126 may then display the image data on monitor 128, which enables the user to see the back of their head, or any other place on their body.

In one embodiment, a secured wireless connection may be established between camera unit 108 and smart device 126, to facilitate wireless communications. Once camera unit 108 is transmitting image data to smart device 126, the user may view the image data on monitor 128. The user may also hold smart device 126 in one hand and camera unit 108, or hair styling tool 100, in the other hand. As a result, the user may see images on the smart device 126 which camera unit 108 is transmitting to smart device 126. For example, the user may orient and position camera unit 108 such that the user may see the back of their head on monitor 128 of smart device 126. In another example, the user may orient and position camera unit 108 such that camera lens is pointed at the user's face to enable the user to see their facial picture in monitor 128, which enables system 102 to act as a substitute for a mirror. In another embodiment, the user may couple camera unit 108 to their finger using handle 124 of camera unit 108. In such an embodiment, camera unit 108 is separated from hair styling tool 100 to enable the user to see hair styling tool 100 in the image.

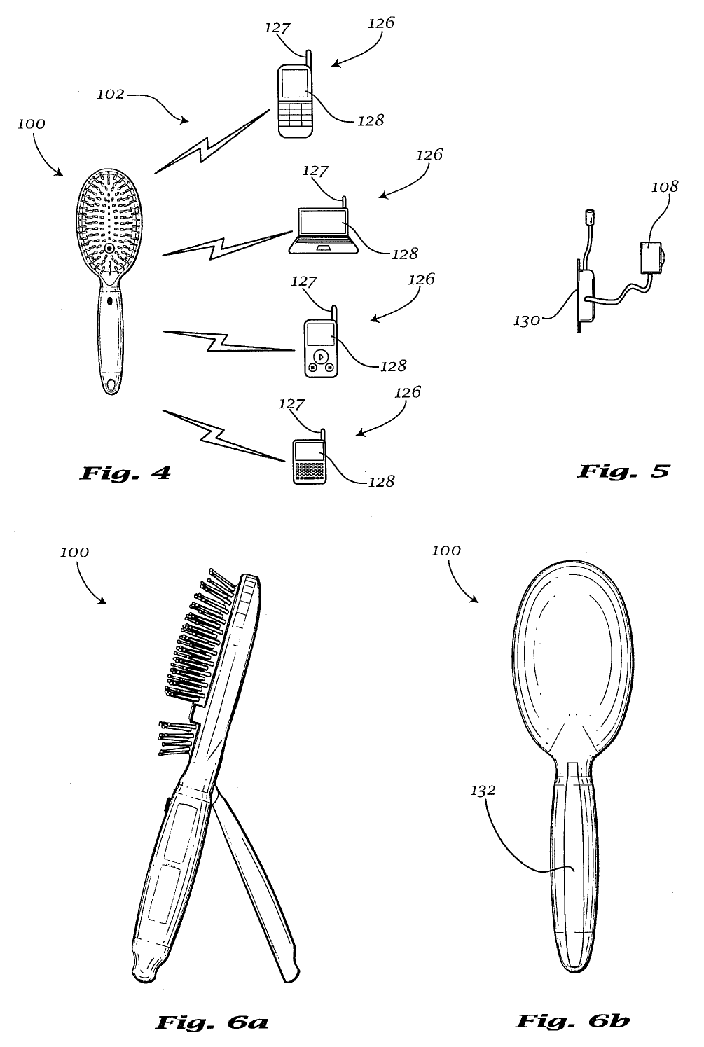

In one embodiment, as shown in FIG. 5, camera unit 108 may be mounted on a wall using a wall mount 130, wherein wall mount 130 is coupled to the wall. Wall mount 130 may be coupled to the wall using a plurality of fasteners (not shown), suction cups, magnets, adhesive stripes, hook and loop fastener structures and/or any other type of fastening means that enables system 102 to function as described herein. In such an embodiment, the user may orient camera unit 108 such that camera lens may be pointed towards the back of the user. The user may then position monitor 128 of smart device 126 such that the user may see the image of the back of their head in monitor 128 to facilitate viewing the back of the user's head or any other part of the user's body that may be difficult to see. As a result, wall mount 130 enables the user to see the back of their head while freeing one of the user's hands.

In the course of operation of the above-described embodiment, the user may couple camera unit 108 to the wall using wall mount 130. Next, the user may activate camera unit 108 and smart device 126 such that a wireless connection may be established therebetween. The user may then orient smart device 126, and more specifically monitor 128, as well as themselves such that camera unit is facing and capturing images of the user. Moreover, the smart device 126 may be positioned such that the user may see themselves in monitor 128, which enables the user to see parts of their body that they may not otherwise be able to see due to the limitation of the human body.

Hair styling tool 100 may also include a folding stand 132, as shown in FIGS. 6a and 6b that may facilitate orienting hair styling tool 100 such that camera unit 108 may face the user. In one embodiment, folding stand 132 may be hingedly coupled to hair styling tool 100 to facilitate balancing hair styling tool 100 such that camera lens 114 may be pointed in a desired direction and/or angle. In a non-limiting example, during operation, the user may place hair styling tool 100 on a substantially flat surface, such as a bathroom counter, and angle camera unit 108 towards the user using folding stand 132. As a result, the user may see themselves in smart device 126, which enables the user to examine themselves. As such, folding stand enables the user to use system 102 as a substitute for a mirror. Alternatively, body portion 104 of hair styling tool 100 may be manufactured with a variety of shapes to facilitate angling camera unit 108 is a specific direction, while hair styling tool 100 is positioned on a flat surface (not shown) such as a counter-top.

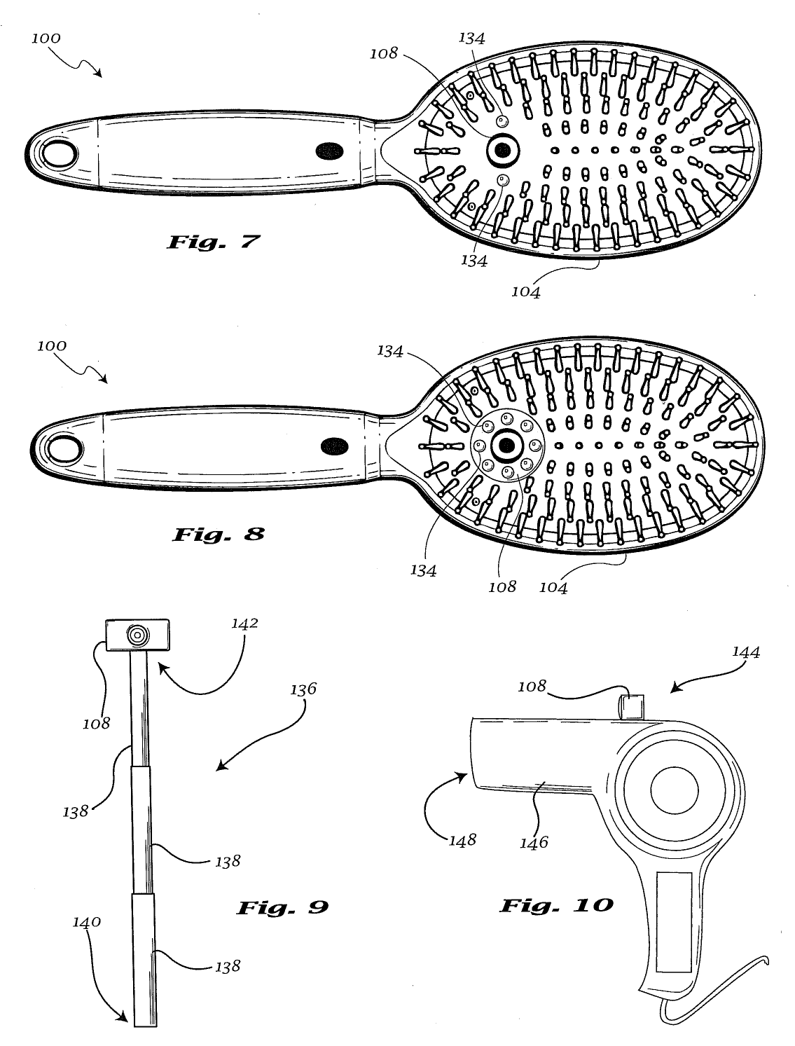

Hair styling tool 100 may include a plurality of lighting objects 134 coupled thereto to facilitate illuminating the object to be filmed. In one embodiment, as shown in FIG. 7, at least one lighting object 134 may be coupled to body portion 104 of hair styling tool 100 such that lighting object 134 facilitates illuminating the object to be filmed. In another embodiment, as shown in FIG. 8, at least one lighting object 134 may be coupled to camera unit 108 to facilitate illuminating the object to be filmed. During operation, the user may activate camera unit 108 such that transmitter 120 is transmitting image data to smart device 126 and the user may view the images on monitor 128. The plurality of lighting objects 134 may facilitate illuminating the object to be filmed, which enables the user to clearly see the images on monitor 128. Moreover, plurality of lighting objects 134 may be specifically helpful in environments where low light facilitates preventing the user from clearly seeing the images displayed on monitor 128 that have been captured by camera lens 114.

In another embodiment, the user may use an extension device 136, as shown in FIG. 9, to facilitate positioning camera unit 108 further away from the user. As a result, the user may view a wide angle picture of themselves. Extension device 136 may include a plurality of extending sections 138 that are slidably coupled to one another and sizes such that extension device 136 may telescope from a compact position (not shown) to an extended position as shown in FIG. 9. Moreover, extension device may include a first end 140 and a second, or terminal, end 142, wherein camera unit 108 may be coupled to terminal end 142. In one embodiment, camera unit 108 may be adjustably coupled to terminal end 142 such that camera unit 108 may be angled and/or rotated with respect to extension device 136. During operation, the user may hold extension device by first end 140 and position second end 142, and more specifically camera unit 108, such that camera lens 114 may capture a wide angle image of the object to be filmed. In the non-limiting example, the user may hold extension device 136 such that camera unit 108 may be positioned a distance away from the user such that the user may see a wide-angle view of themselves. Moreover, the user may orient camera unit 108 such that camera lens 114 captures images of the user and transmits the images using transmitter 120 to monitor 128 of smart device 126.

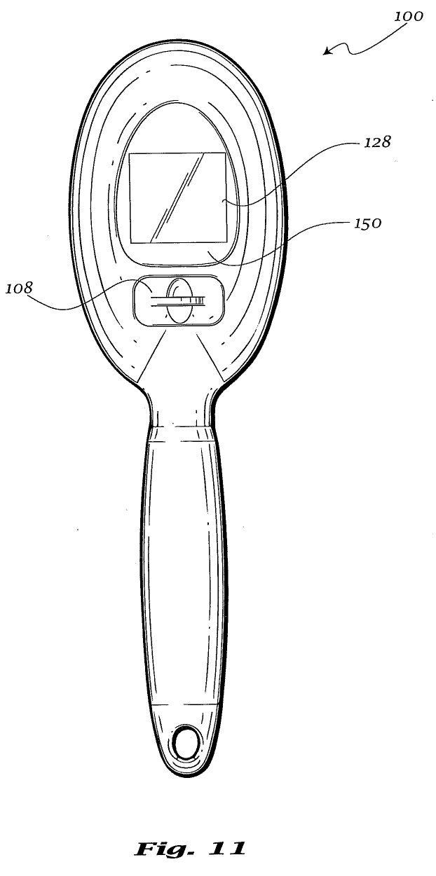

In another alternative embodiment, as shown in FIG. 10, hair styling tool 100 may be a hair dryer 144 that may include camera unit 108 coupled thereto. In one embodiment, camera unit 108 may be coupled to a housing 146 of hair dryer 144 such that camera unit 108 is aimed towards an exhaust outlet 148 and more specifically, in the direction of the airflow. As a result, camera unit 108 may capture images of objects positioned adjacent exhaust outlet 148, and more specifically, objects positioned substantially in a line-of-sight of camera unit 108.

Camera unit 108 may include a universal mounting bracket (not shown) that facilitates coupling camera unit 108 to a plurality of styling tools. For example, in one embodiment, camera unit 108 may be coupled to a lint brush (not shown) using universal mounting bracket. In another embodiment, the user may user universal mounting bracket to facilitate coupled camera unit 108 to the user's favorite hair styling tool 100.

FIG. 11 is a perspective view of an alternative embodiment of hair styling tool 100 that may include an integrated monitoring unit 150, wherein integrated monitoring unit 150 may be detachable from hair styling tool 100. Integrated monitoring unit 150 may include display 128, an internal receiver (not shown) and a power source (not shown). During operation, the user may detach and place integrated monitoring unit 150 in a position where the user may substantially see integrated monitoring unit 150. Then, the user may activate camera unit 108 which may begin capturing images using camera lens 114 and transmitting the images using transmitter 120 to integrated monitoring unit 150. In the non-limiting example, the user may use camera unit 108 and integrated monitoring unit 150 to view the back of the user's head or other areas of the user's body.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A hair styling apparatus comprising:
a body portion;
a handle portion extending away from said body portion; and
a camera unit coupled to said body portion, said camera unit comprising:
a camera unit body portion;
a lens coupled to said camera unit body portion; and
a transmitter coupled within said camera unit body portion, wherein said transmitter is operatively coupled to said lens.

2. A hair styling apparatus in accordance with claim 1, wherein said body portion further comprises a plurality of bristles extending substantially perpendicularly away therefrom, wherein said camera unit is positioned such that said lens is aimed in a direction that is substantially parallel to said plurality of bristles.

3. A hair styling apparatus in accordance with claim 1, wherein said handle portion further comprises a stand hingedly coupled thereto.

4. A hair styling apparatus in accordance with claim 1, wherein said handle portion further comprises at least one first extension section slidably coupled to at least one second extension section to facilitate telescopically sliding said at least one first extension section with respect to said at least one second extension section.

5. A hair styling apparatus in accordance with claim 1, wherein said body portion comprises an aperture defined therein, wherein said camera unit is removably coupled to said body portion and positioned within said aperture.

6. A hair styling apparatus in accordance with claim 1 further comprising a switch coupled to said handle portion, said switch facilitates at least one of turning on said camera unit and turning off said camera unit.

7. A hair styling apparatus in accordance with claim 1, wherein said camera unit further comprises a handle extending away therefrom.

8. A hair styling apparatus in accordance with claim 1, wherein said body portion further comprises at least one lighting object coupled thereto.

9. A hair styling apparatus in accordance with claim 1, wherein said camera unit further comprises at least one lighting object coupled thereto.

10. A hair styling apparatus in accordance with claim 1 further comprising a second power source coupled within said handle portion.

11. A hair styling apparatus in accordance with claim 1, wherein said camera unit further comprises a power source coupled within said camera unit body portion, wherein said power source is operatively coupled to at least one of said lens and said transmitter.

12. A hair styling system comprising:
a hair styling apparatus comprising:
a body portion;
a handle portion extending away from said body portion; and
a camera unit coupled to said body portion, said camera unit comprising:
a camera unit body portion;
a lens coupled to said camera unit body portion; and
a transmitter coupled within said camera unit body portion,
wherein said transmitter is operatively coupled to said lens; and
at least one smart device coupled in communication with said hair styling apparatus, said at least one smart device comprising:
a transceiver; and
a monitor operatively coupled to said transceiver to facilitate displaying image data received by said transmitter.

13. A hair styling system in accordance with claim 12, wherein said at least one smart device is removably coupled to said hair styling apparatus.

14. A hair styling system in accordance with claim 12, wherein said at least one smart device further comprises at least one of a mobile telephone, a television, a computer, a personal digital assistant, a music player, a video player and a video game player.

15. A hair styling system in accordance with claim 12 further comprising a wall mount, wherein said at least one smart device is coupled to said wall mount.

16. A hair styling system in accordance with claim 12, wherein said body portion further comprises a plurality of bristles extending substantially perpendicularly away therefrom, wherein said camera unit is positioned such that said lens is aimed in a direction that is substantially parallel to said plurality of bristles.

17. A hair styling system in accordance with claim 12, wherein said body portion further comprises an aperture defined therein, wherein said camera unit is removably coupled to said body portion and positioned within said aperture.

18. A hair styling system in accordance with claim 12, wherein said hair styling apparatus further comprises at least one of a hair brush and a hair dryer.

19. A hair styling system in accordance with claim 12 further comprising a switch coupled to said handle portion, said switch facilitates at least one of turning on said camera unit and turning off said camera unit.

20. A means for capturing and transmitting image data, said means comprising:
means for capturing image data using a hair styling apparatus;
means for transmitting image data to at least one smart device; and
means for displaying image data on the at least one smart device.
